(19) United States
(12) Patent Application Publication
(10) Pub. No.: US 2005/0090213 A1
(43) Pub. Date: Apr. 28, 2005

(54) Tuner and demodulator for analog cable television

(76) Inventors: Chun Huat Heng, La Jolla, CA (US); Manoj Gupta, La Jolla, CA (US); Sanghoon Lee, Chuncheon-si (KR); David Dukho Kang, Fullerton, CA (US)

Correspondence Address: CARR & FERRELL LLP, 2200 GENG ROAD, PALO ALTO, CA, 94303, US

(21) Appl. No.: 10/836,545

(22) Filed: Apr. 30, 2004

Related U.S. Application Data
(60) Provisional application No. 60/514,215, filed on Oct. 23, 2003.

(51) Int. Cl. H04B 1/18

(52) U.S. Cl. 455/154.1; 455/150.1

(57) ABSTRACT

A tuner and demodulator performing image rejection in an analog cable television system. Various embodiments disclose a tuner including an analog RF section to generate a complex intermediate frequency digital signal, an image rejection module configured to perform image rejection on the complex intermediate frequency digital signal to generate an enhanced image rejection signal, a signal channel select filter configured to perform digital on-chip filtering on the enhanced image rejection signal to generate a filtered signal, and a demodulator configured to demodulate the filtered signal to generate digital output signals. In some embodiments, the tuner is substantially or fully monolithic. In some embodiments, the tuner performs image rejection by applying an algorithm to estimate a signal correlation between the signal band and the image band of the complex intermediate frequency digital signal, and providing adaptive filtering to reduce signal leakage and image leakage.

### CROSS-REFERENCE TO RELATED APPLICATION

This application claims the priority and benefit of U.S. Provisional Patent Application Ser. No. 60/514,215 entitled “A TUNER AND DEMODULATOR FOR ANALOG CABLE TELEVISION,” filed on Oct. 23, 2003, which is hereby incorporated by reference.

### BACKGROUND OF THE INVENTION

1. Field of the Invention

The present invention relates generally to systems and methods for tuning and demodulating radio frequency (RF) signals, and more particularly, to a tuner and demodulator providing image rejection.

2. Description of Related Art

Analog cable television (also known as “CATV”) brings television programs to millions of viewers throughout the world. Analog cable television is transmitted using a radio frequency signal that comprises several channels or bands of signals. In order to effectively present a channel to a viewer, an electronic device, such as a tuner, is used to separate and process one channel for presentation.

Tuners may be fabricated on circuit boards and then installed in computer systems, thereby allowing the computer system to operate as a television set. Many tuners convert high frequency RF signals to one or more Intermediate Frequency (IF) signals which, at a later step, are converted to baseband signals. Such IF signals are at a lower frequency than the RF signals. Each translation stage normally uses mixing to produce both a desired signal and an image signal. If the image signal falls into the same IF frequency band as the desired signal, the image signal should be removed from the desired signal. This process of correcting the desired signal by removing the image signal is referred to as image rejection.

Some existing tuners provide image rejection through the use of off-chip fixed filters, such as external Surface Acoustic Wave (SAW) filters. Such off-chip filters require additional pins and interface components, thus increasing power consumption and packaging costs. Other existing tuners have attempted to provide on-chip analog filters to perform image rejection; however, such tuners require costly and complicated circuitry to provide desired signal accuracy.

There exists a need for a fully integrated tuner and demodulator that provides improved digital image rejection.

### BRIEF SUMMARY OF THE INVENTION

This invention provides systems and methods for tuning and demodulating radio frequency signals, and more particularly, to a tuner and demodulator for analog cable television providing image rejection.

The preferred embodiment of the present invention provides a tuner, fully integrated on a computer chip, for tuning a radio frequency signal for analog cable television. The tuner comprises an analog RF section configured to process the radio frequency signal to generate a complex intermediate frequency digital signal, an image rejection module configured to perform image rejection on the complex intermediate frequency digital signal to generate an enhanced image rejection signal, a signal channel select filter configured to perform digital on-chip filtering on the enhanced image rejection signal to generate a filtered signal, and a demodulator configured to demodulate the filtered signal to generate digital output signals.

The analog RF section comprises an amplifier, configured to manage peak amplitudes of the radio frequency (RF) signal; a synthesizer, configured to synthesize a first synthesized signal and a second synthesized signal; an up-conversion module, configured to receive the RF signal from the amplifier and the first synthesized signal from the synthesizer to increase the frequency of the radio frequency signal, resulting in an intermediate frequency signal; a tuning amplifier, configured to reduce harmonics of the intermediate frequency signal; a down-conversion module, configured to receive the intermediate frequency signal from the tuning amplifier and the second synthesized signal from the synthesizer to decrease the frequency of the intermediate frequency signal, resulting in a complex intermediate frequency signal; a filter/gain control module, configured to perform anti-aliasing on the complex intermediate frequency signal and manage gain variations of the complex intermediate frequency signal; and a analog-to-digital converter module, configured to convert the complex intermediate frequency signal to a complex intermediate frequency digital signal.

In a preferred embodiment, the invention provides a tuner for tuning a complex intermediate frequency digital signal, the complex intermediate frequency digital signal comprising a signal band and an image band. The tuner comprises an image rejection module, configured to apply an algorithm to estimate a signal correlation between the signal band and the image band, and an adaptive filter, including adaptive filter coefficients, configured to filter the image signal according to the adaptive filter coefficients, whereby the image rejection module applies the adaptive filter to the image band to estimate an image leakage, and whereby the image rejection module subtracts the image leakage from the signal band, thereby reducing the image leakage in the signal band. In some embodiments, the algorithm comprises an adaptive complex least-mean-square algorithm.

In another embodiment, the invention provides a method for tuning a radio frequency signal, comprising processing the radio frequency signal to generate a complex intermediate frequency digital signal, performing image rejection on the complex intermediate frequency digital signal to generate an enhanced image rejection signal, performing digital on-chip filtering on the enhanced image rejection signal to generate a filtered signal, and demodulating the filtered signal to generate digital output signals.

### BRIEF DESCRIPTION OF THE DRAWINGS

FIG. 1A illustrates a high level overview diagram of an RF analog section of a tuner for analog cable television, according to an embodiment of the invention;

FIG. 1B illustrates a high level overview diagram of a signal processing section of a tuner for analog cable television, according to an embodiment of the invention;

FIG. 2A illustrates an architecture diagram of the analog RF section of the tuner illustrated in FIG. 1A, according to an embodiment of the invention;

FIG. 2B illustrates an architecture diagram of the signal processing section of the tuner illustrated in FIG. 1B, according to an embodiment of the invention;

FIG. 3 illustrates a topology diagram of an oscillator, according to an embodiment of the invention;

FIG. 4 illustrates a circuit diagram of an analog-to-digital converter, according to an embodiment of the invention;

FIG. 5 illustrates a circuit diagram of a complex LMS (“Least-Mean-Square”) image rejection module, according to an embodiment of the invention;

FIG. 6 illustrates a block diagram of a signal channel select filter, according to an embodiment of the invention;

FIG. 7 illustrates a circuit diagram of a second-order biquadratic filter, according to an embodiment of the invention;

FIG. 8 illustrates a circuit diagram of an exemplary demodulator, according to an embodiment of the invention; and

FIG. 9 illustrates a process flow diagram for tuning a radio frequency signal, according to an embodiment of the invention.

### DETAILED DESCRIPTION OF INVENTION

Various embodiments of the invention provide systems and methods for tuning and demodulating radio frequency signals, and more particularly, provide a tuner and demodulator providing image rejection for analog cable television.

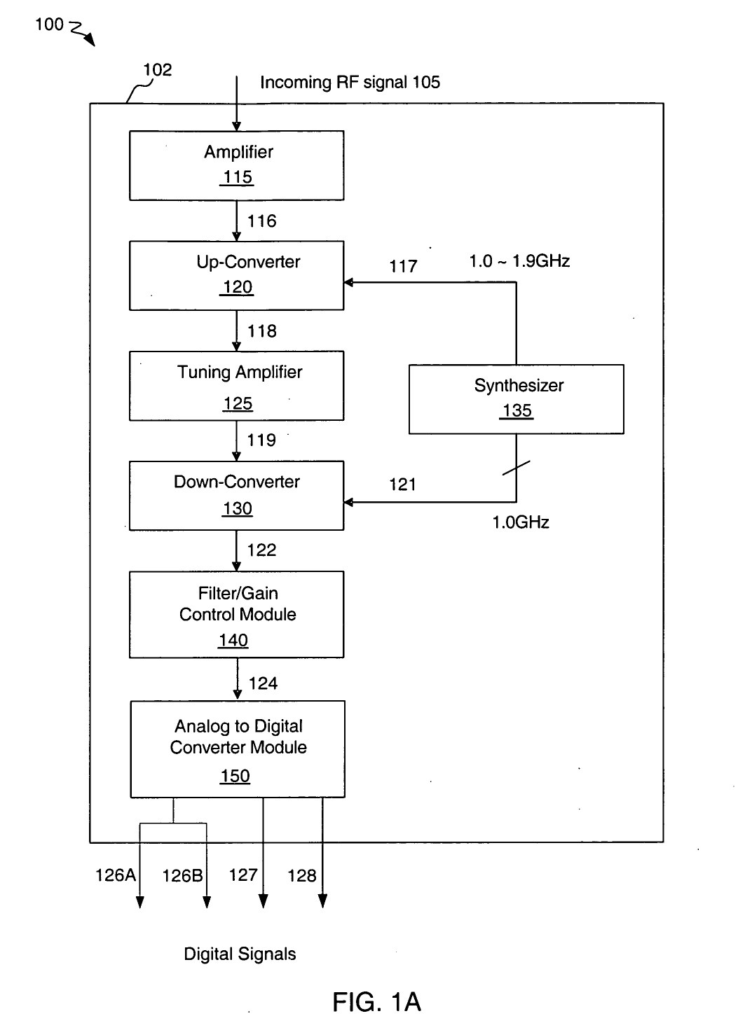

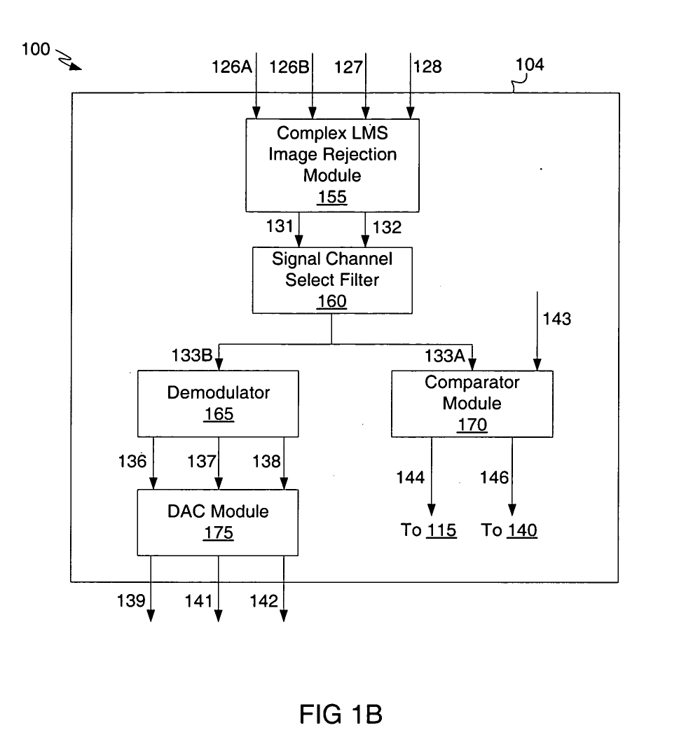

FIGS. 1A and 1B illustrate high-level overview diagrams of a tuner 100 comprising an analog RF section 102 (FIG. 1A) and a signal processing section 104 (FIG. 1B), according to an embodiment of the invention. In the preferred embodiment, the tuner 100 is constructed on a single integrated chip. An integrated circuit (not shown) comprising the tuner 100 may be constructed with 0.25 μm RF Complementary Metal Oxide Semiconductor (CMOS) components consuming approximately 1 W and operating on a 6 mm×6 mm die. The tuner 100 comprises an amplifier 115, an up-converter 120, a tuning amplifier 125, a down-converter 130, a synthesizer 135, a filter/gain control module 140, an analog-to-digital converter module 150, a complex LMS image rejection module 155, a signal channel select filter 160, a demodulator 165, a comparator module 170, and a digital-to-analog converter (DAC) module 175.

FIG. 1A illustrates the analog RF section 102 of the tuner 100. As illustrated in FIG. 1A, the amplifier 115 receives an incoming RF signal 105. The amplifier 115 amplifies the incoming RF signal 105 and transmits the amplified signal 116 to the up-converter 120. The amplifier 115 preferably comprises a variable gain low noise amplifier, configured to maintain constant peak amplitude for the signal. In one embodiment of the invention, the amplifier 115 is a common source amplifier (not shown) utilizing three controls for managing the gain. A first control adjusts the gain as a function of amplifier linearity. Typically, reducing the gain increases amplifier linearity. A second control varies a load resistor (not shown) of amplifier 115. Thus, the first control and the second control in combination preferably provide a coarse gain adjustment. A third control provides a fine gain adjustment by adjusting a current flow through the load resistor (not shown). In a preferred embodiment, the gain is adjusted in 0.85 dB increments. The up-converter 120 receives the amplified signal 116 from the amplifier 115 and a first synthesized signal 117 from the synthesizer 135. The up-converter 120 comprises any device capable of increasing the frequency of a signal. In the preferred embodiment, the up-converter 120 changes the frequency of the amplified signal 116 to approximately 1.0 GHz, resulting in an intermediate frequency (IF) signal 118. According to the preferred embodiment of the invention, the up-converter 120 (or “up-mixer”) comprises a conventional Gilbert four-quadrant multiplier. A Gilbert four-quadrant multiplier configured with bipolar junction transistors is disclosed by Barrie Gilbert, “A Precise Four-Quadrant Multiplier with Subnanosecond Response,” IEEE Journal of Solid State Circuits, Vol. SC-3, pp. 365-373, December 1968, herein incorporated by reference. As known to one skilled in the art, the Gilbert four-quadrant multiplier may be implemented with MOS or bipolar transistors. The up-converter 120 may employ a tuning inductor coupled to an output of the Gilbert four-quadrant multiplier to advantageously suppress harmonics in the generated IF signal 118. The up-converter 120 transmits the IF signal 118 to the tuning amplifier 125.

As illustrated in FIG. 1A, the tuning amplifier 125 receives the IF signal 118 from the up-converter 120. The tuning amplifier 125 preferably comprises any device capable of suppressing harmonics resulting from mixing. The tuning amplifier 125 suppresses the harmonics of the IF signal 118 and transmits a resulting signal 119 to the down-converter 130. In one embodiment, the up-converter 120 and the tuning amplifier 125 are configured to provide a collective gain of 6 dB. The down-converter 130 receives the resulting signal 119 from the tuning amplifier 125 and a second synthesized signal 121 from the synthesizer 135. The down-converter 130 changes the frequency of the resulting signal 119 received from the tuning amplifier 125 to approximately 1.75 MHz, resulting in a complex IF signal 122. According to a preferred embodiment of the invention, the down-converter 130 (or “down-mixer”) comprises two stages. A first stage may be a conventional Gilbert four-quadrant multiplier similar to the four-quadrant multiplier that is described in reference to the up-converter 120. In one embodiment, the first stage further comprises an active current source coupled across first stage output nodes as a load. Using the active current source advantageously enables the down-converter 130 to handle large currents with reduced or minimal voltage drops. A second stage may comprise a conventional trans-impedance amplifier, wherein a gain is mainly set by a feedback resistor, as is known to one skilled in the art. In one embodiment, the down-converter 130 is configured to provide a gain of 16 dB. The down-converter 130 transmits the complex IF signal 122 to the filter/gain control module 140. In one embodiment, the synthesizer 135 is configured to generate the first synthesized signal 117 with a frequency of approximately 1.0 GHz to 1.9 GHz (one octave) and the second synthesized signal 121 with a frequency of approximately 1.0 GHz.

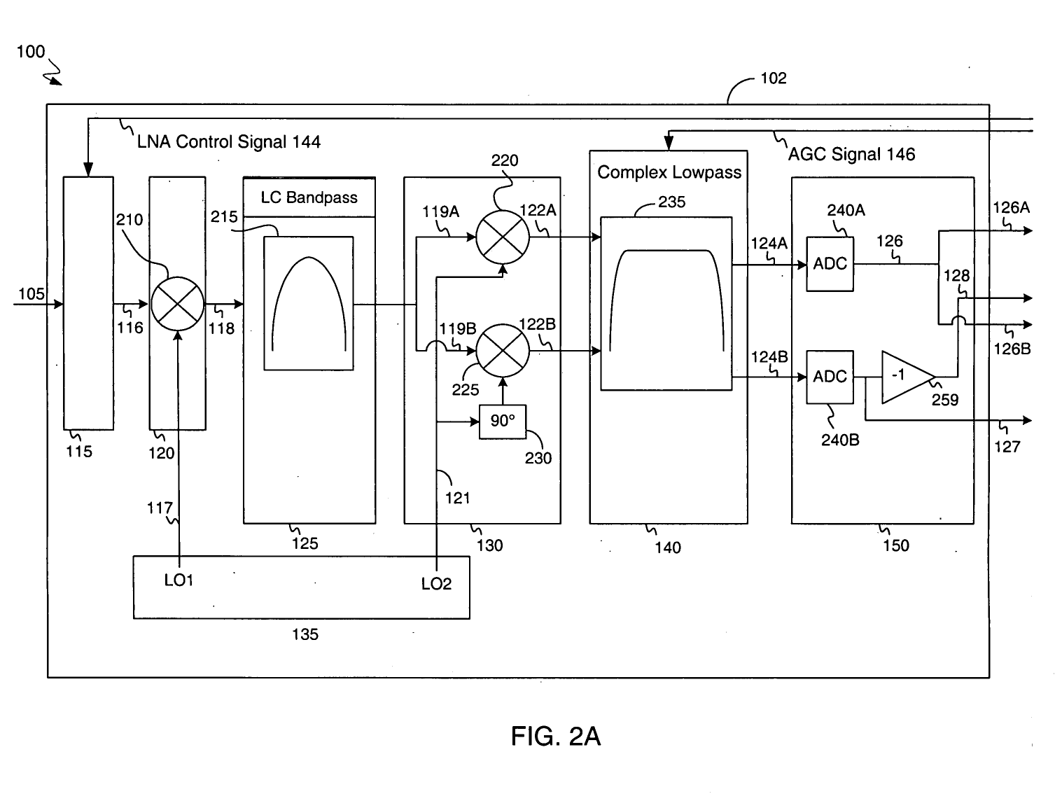

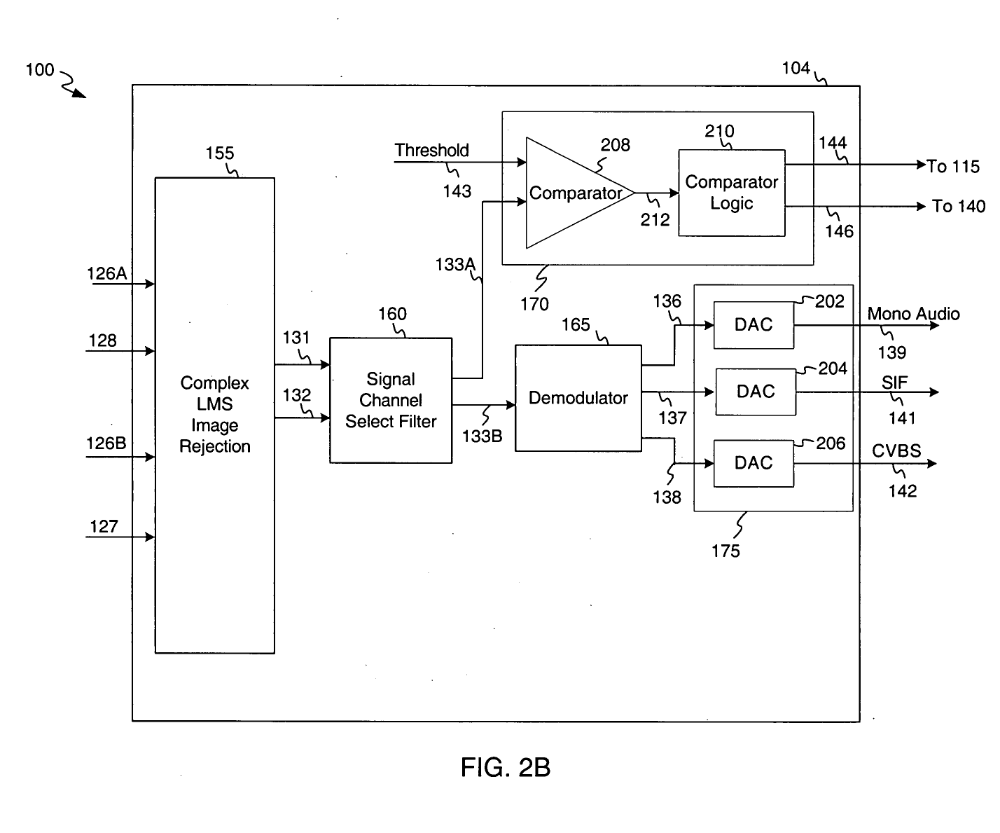

Filter/gain control module 140 comprises any device or devices configured to perform complex low pass filtering and gain control on the complex IF signal 122. In operation, the filter/gain control module 140 performs anti-aliasing on the complex IF signal 122 received from the down-converter 130, adjusts the gain of the anti-aliased signal, and transmits a gain-adjusted signal 124 to the analog-to-digital converter module 150. According to a preferred embodiment of the invention, the filter/gain control module 140 comprises a conventional 10th order Butterworth complex low-pass filter with a 9 MHz cut-off corner to perform anti-aliasing. The conventional 10th order Butterworth complex low-pass filter of the filter/gain control module 140 is discussed further below in conjunction with FIG. 2A. As is known to one skilled in the art, the 10th order Butterworth complex low-pass filter utilizes 10 stages, with each stage determining one pole of the complex low-pass filter. The filter/gain control module 140 may comprise any device that performs gain control on the anti-aliased signal and adjusts the gain as a function of a specified parameter.

In some embodiments, the analog-to-digital converter module 150 comprises two analog-to-digital converters (ADCs). The analog-to-digital converter 150 module preferably comprise two 11-bit pipeline ADCs configured to receive the gain-adjusted signal 124 and convert in-phase and quadrature-phase components of the gain-adjusted signal 124. In the preferred embodiment, the analog-to-digital converter module 150 generates quantized (i.e., complex IF digital) signals 126A, 126B, 127, and 128

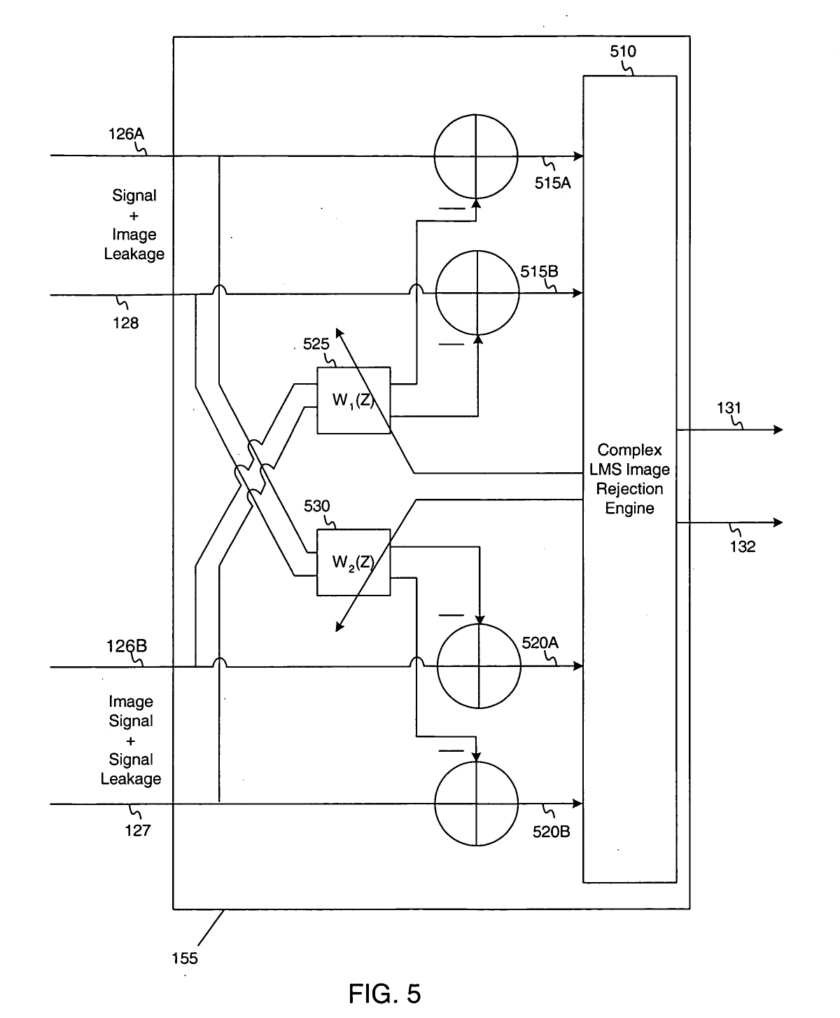

FIG. 1B illustrates the signal processing section 104 of the tuner 100. As illustrated, the complex LMS image rejection module 155 receives the complex IF digital signals 126A, 126B, 127, and 128 from the analog to digital converter module 150 (FIG. 1A). The complex LMS image rejection module 155 reduces image leakage in a signal band and signal leakage in an image band to generate signals 131 and 132. The complex LMS image rejection module 155 is discussed further below in conjunction with FIG. 2B and FIG. 5. A signal channel select filter 160 receives the signals 131 and 132, and performs channel selection and filtering on the signals 131 and 132 to generate an output signal 133A to the comparator module 170 and an output signal 133B to the demodulator 165. The demodulator 165 performs audio/video demodulation of the output signal 133B to generate three digital output signals 136, 137, and 138. The three digital output signals 136, 137, and 138 are transmitted to the DAC module 175. The DAC module 175 generates three signals: a mono audio signal 139, a SIF (Sound IF) signal 141, and a composite video baseband signal (CVBS) 142.

The comparator module 170 receives the output signal 133A and a predefined threshold signal 143, compares the output signal 133A with the predefined threshold signal 143, and generates control signals 144 and 146. The control signals 144 and 146 are transmitted to the amplifier 115 and filter/gain control module 140, respectively, to digitally control gain of the amplifier 115 and the filter/gain control gain module 140.

FIG. 2A illustrates an architecture diagram of the analog RF section 102 of the tuner 100 illustrated in FIG. 1A, according to a preferred embodiment of the invention. Various other embodiments of the invention may utilize different circuit architectures. The analog RF section 102 is configured to process an analog RF signal. As illustrated in FIG. 2A, the amplifier 115 receives and amplifies the RF signal 105, and sends the amplified signal 116 to the mixer 210. The mixer 210 mixes the amplified signal 116 from the amplifier 115 with a signal 117 from a first local oscillator (LO1) of the synthesizer 135. The amplified signal 116 preferably comprises a signal with frequency from 48 MHz to 860 MHz. The mixer 210 preferably produces a signal 118 of frequency 1.0 GHz to an inductor-capacitor (LC) bandpass filter 215. The LC bandpass filter 215 is configured to suppress the harmonics that result from the mixer 210. The LC bandpass filter 215 produces a signal 119 to a mixer 220 and a mixer 225. The mixer 220 mixes a signal 119A from the LC bandpass filter 215 with a signal 121 from a second oscillator (LO2) of the synthesizer 135 to produce a signal 122A to a complex lowpass filter 235 of the filter/gain control module 140. In addition, the mixer 225 mixes a signal 119B from the LC bandpass filter 215 with the signal 121 from the second oscillator LO2, after the LO2 signal 121 has passed through a 90 degree phase shifter 230, to produce a signal 122B to the complex lowpass filter 235 of the filter/gain control module 140. In the preferred embodiment, the mixer 220 and the mixer 225 are configured to produce a signal 122 with a frequency of 1.75 MHz with both in-phase and quadrature-phase signal components. The complex lowpass filter 235 of the preferred embodiment comprises a conventional 10th order Butterworth lowpass complex filter with a cutoff frequency of 9 MHz, an exemplary embodiment of which is implemented by Jan Crols and Michiel Steyaert as disclosed in “An Analog Integrated Polyphase Filter For A High Performance Low-IF Receiver,” Symposium on VLSI Circuits, pp 87-88, 1995, incorporated herein by reference. The complex lowpass filter 235 is configured to perform anti-aliasing on the signal 122 received from the mixer 220 and the mixer 225. In one embodiment, the filter/gain control module 140 additionally comprises a gain control module (not shown) that processes the anti-aliased signal produced by the complex lowpass filter 235 and compensates for possible gain variation along the signal line.

In one embodiment, the filter/gain control module 140 produces a first signal 124A to an analog-to-digital converter (ADC) 240A of the analog-to-digital converter module 150, and a second signal 124B to an ADC 240B of the analog-to-digital converter module 150. The ADC 240A and the ADC 240B preferably comprise an 11-bit pipeline ADC. The ADC 240A produces a digital signal 126 to the complex LMS image rejection module 155 (FIG. 2B). The ADC 240B produces a digital signal 127 to an inverter 259 and to the complex LMS image rejection module 155. The inverter 259 inverts the received digital signal 127, and sends an inverted digital signal 128 to the complex LMS image rejection module 155.

FIG. 2B illustrates an architecture diagram of the signal processing section 104 of tuner 100 illustrated in FIG. 1B, according to a preferred embodiment of the invention. As illustrated in FIG. 2B, the complex LMS image rejection module 155 generates digital signals 131 and 132 by processing the received digital signals 126A, 126B, 127 and 128 to reduce image and signal leakage. In the preferred embodiment, the complex LMS image rejection module 155 applies the following adaptive algorithm:
W₁^{k+1}[m]=W₁^{k}[m]+μ₁u₂[k]u₁[k−m]
W₂^{k+1}[m]=W₂^{k}[m]+μ₂u₁[k]u₂[k−m]
m=0 . . . L

In the above algorithm, W1 is an adaptive filter coefficient for signal estimate, W2 is an adaptive filter coefficient for image estimate, μ1 is an LMS adjustment step size for W1, μ2 is an LMS adjustment step size for W2, u1 is a signal output, u2 is an image output, m is a mth tap of an adaptive filter, and L is a number of taps. The complex LMS image rejection module 155 is discussed further below in conjunction with FIG. 5.

The signal channel select filter 160 receives the signals 131 and 132, and filters the received signals 131 and 132 to generate signals 133A and 133B. Next, the demodulator 165 receives the signal 133B (comprised of in-phase I and quadrature-phase Q components), and generates three digital signals 136, 137, and 138 to the DAC module 175. In one embodiment of the invention, the DAC module 175 comprises DACs 202, 204, and 206. In alternate embodiments, the DAC module 175 may comprise any number of digital-to analog converters. The DACs 202, 204, and 206 convert the digital signals 136, 137, and 138 to an analog mono audio signal 139, an analog SIF signal 141, and an analog CVBS 142, respectively.

The comparator module 170 comprises a comparator 208 and a comparator logic module 210. In operation, the comparator 208 receives the signal 133A (comprised I and Q components) and the predefined threshold signal 143, and generates a signal 212 based upon a difference between a magnitude of the threshold signal 143 and a magnitude of the signal 133A. The comparator logic module 210 receives the signal 212, and based upon the signal 212, generates the control signal 144 (i.e., a low noise amplifier (LNA) control signal) and the control signal 146 (i.e., a automatic gain control (AGC) signal). The LNA control signal 144 is transmitted to the amplifier 115 (FIG. 2A) to digitally control gain of the amplifier 115, and the AGC control signal 146 is transmitted to the filter/gain control module 140 (FIG. 2A) to digitally control gain of the filter/gain control gain module 140.

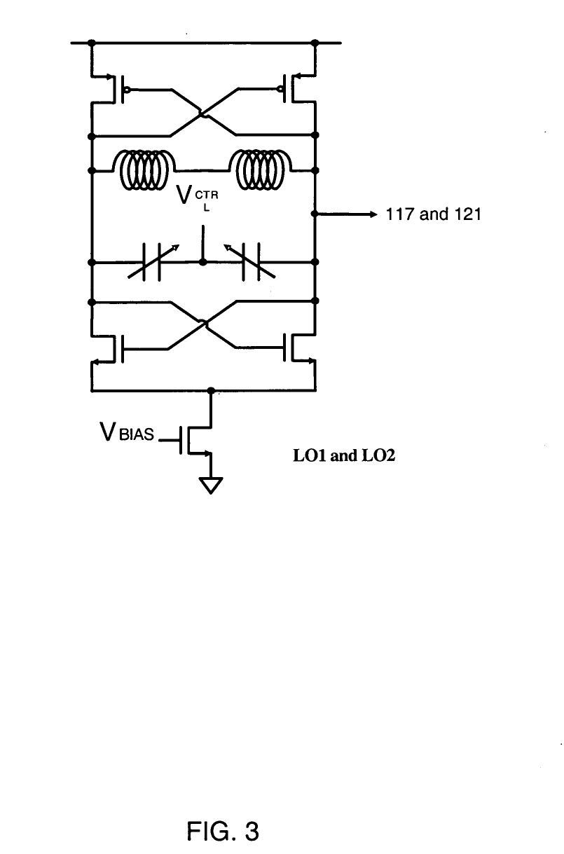

FIG. 3 illustrates a topology diagram of an exemplary first local oscillator LO1 of the synthesizer 135, according to the preferred embodiment of the invention. The exemplary first local oscillator LO1 covers a frequency range from 1.0 GHz to 1.9 GHz using the topology illustrated in FIG. 3. The exemplary first local oscillator LO1 advantageously comprises an LC oscillator to utilize an LC oscillator's phase noise performance. In one embodiment, three LC oscillators are utilized to increase the limited tuning range of a single LC oscillator in order to cover the desired frequency range of LO1, namely from about 1.0 GHz to 1.9 GHz, each LC oscillator covering a portion of the entire frequency range. Therefore, as an example, one LC oscillator covers the 1.0 to 1.3 GHz range, a second LC oscillator covers the 1.3 to 1.6 GHz range, and a third LC oscillator covers the 1.6 to 1.9 GHz range.

FIG. 3 also illustrates a preferred topology of an exemplary second local oscillator LO2 of the synthesizer 135. The exemplary second local oscillator LO2 is configured to synthesize a 1.0 GHz frequency signal. In order to generate the two phases (i.e. in-phase and quadrature-phase), the second local oscillator LO2 is configured to cover at least twice the frequency of the signal 119 received by the down-converter 130 (FIG. 1). For example, if a frequency of the signal 119 is 1.0 GHz, the second local oscillator LO2 is configured to cover a frequency of 2.0 GHz. The second local oscillator LO2 is further configured to divide the output frequency by two, in order to generate the two phases (i.e. in-phase and quadrature-phase).

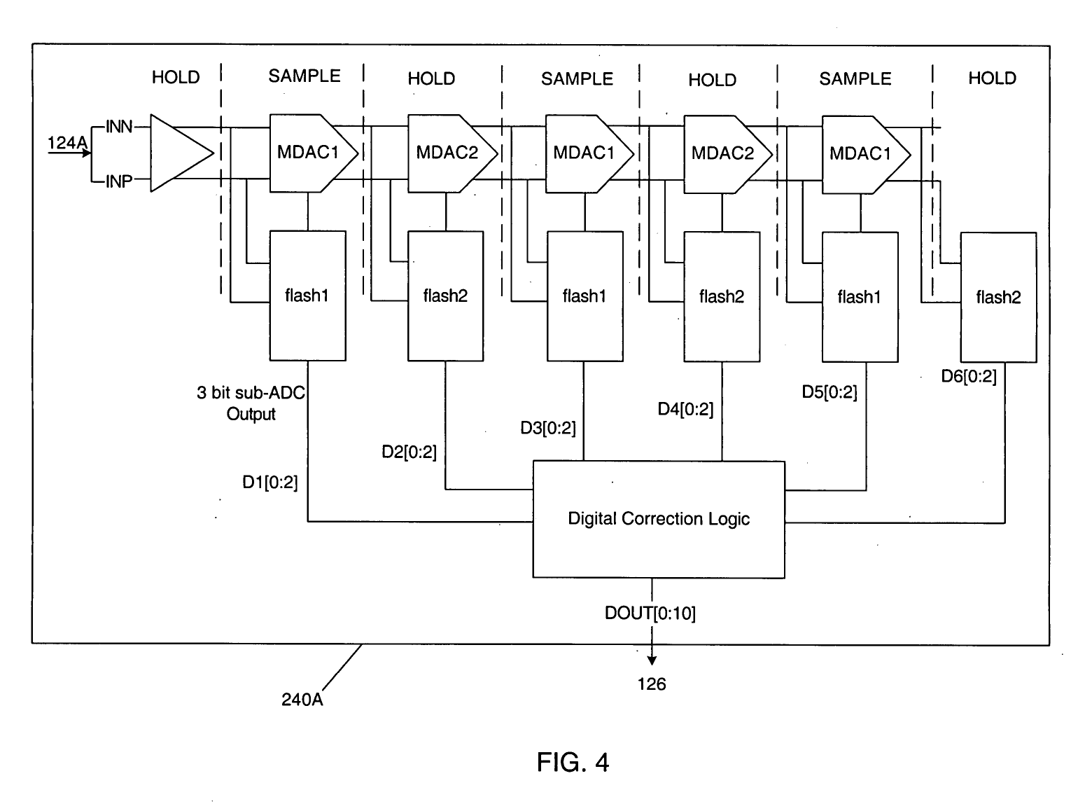

FIG. 4 illustrates a circuit diagram of the analog-to-digital converter 240A, according to the preferred embodiment of the invention. The analog-to-digital converter 240A, incorporated herein by reference to B. S. Song, “10-b 15 MHz Recycling Two-Step A/D Converter,” IEEE J. Solid-State Circuits, vol. 25, pp. 1328-1337, December 1990, preferably comprises a conventional 11-bit pipeline ADC comprising 6 stages with each stage resolving 2.5 bits, as is known to one skilled in the art. Each stage comprises a flash ADC, such as a flash1 module or a flash2 module, for coarsely converting an analog input signal to a three-bit digital output signal. In addition, each stage comprises an MDAC, such as MDAC1 or MDAC2, for receiving the analog input signal and the three-bit digital output signal, converting the three-bit digital output signal to a converted analog signal, subtracting the converted analog signal from the analog input signal to generate a difference signal, amplifying the difference signal, and sending the amplified difference signal to the next stage. The three-bit digital output signal generated by each flash ADC is transmitted to a digital correction logic module. The digital correction logic module combines the three-bit digital output signals from the flash ADCs to generate an eleven-bit output signal 126. The analog-to-digital converter 240B is similar to the analog-to-digital converter 240A, and will not be further described.

FIG. 5 illustrates an exemplary circuit diagram of the complex LMS (“Least-Mean-Square”) image rejection module 155 shown in FIG. 2B, according to a preferred embodiment of the invention. The complex LMS image rejection module 155 comprises a complex LMS image rejection engine 510 configured to apply a complex LMS algorithm to estimate the correlation between a signal and an image. As illustrated in FIG. 5, the complex LMS image rejection module 155 receives a signal plus image leakage from the analog-to-digital converter module 150 comprised of the digital signal 126A (i.e., an in-phase signal I) and the digital signal 128 (i.e., an inverted complex multiple of the quadrature signal −jQ). The complex LMS image rejection module 155 also receives an image signal plus signal leakage from the analog-to-digital converter module 150 comprised of the digital signal 126B (i.e., the in-phase signal I) and a digital signal 127 (i.e., a complex multiple of the quadrature signal jQ). When there is mismatch along the two signal paths (I path and Q path), an image leakage appears in the signal band and a signal leakage appears in the image band. It is typical to have a phase imbalance of less than 5 degrees and gain mismatch of 0.5 dB along the two signal paths, which results in −40 dB of image leakage in the signal band or signal leakage in the image band. In operation, the complex LMS image rejection engine 510 receives a signal 515 and an image 520, and estimates a correlation between the signal 515 and the image 520. Then, the estimated correlation is used by the complex LMS image rejection module 155 to adjust adaptive filter coefficients W1 and W2 of adaptive filters 525 and 530, respectively, to minimize the correlation. The complex LMS image rejection module 155 then applies the adaptive filter coefficient W1 to the image signal plus signal leakage (i.e., to I 126B and jQ 127) to generate an estimate of the image leakage, and applies the adaptive filter coefficient W2 to the signal plus image leakage (i.e., to I 126 and −jQ 128) to generate an estimate of the signal leakage. The complex LMS image rejection module 155 then subtracts the estimated image leakage from the signal plus image leakage (i.e., from I 126A and −jQ 128), and subtracts the estimated signal leakage from the image signal plus signal leakage (i.e., from I 126B and jQ 127). By reducing the correlation, the image leakage in the signal band is reduced and the signal leakage in the image band is reduced, and the complex LMS image rejection module 155 generates the signal 131 comprised of an in-phase component I, and the signal 132 comprised of a quadrature component Q. The signals 131 and 132 may also collectively be referred to as an enhanced image rejection signal.

In the preferred embodiment, the complex LMS image rejection module 245 is configured to apply the following algorithm:
W₁^{k+1}[m]=W₁^{k}[m]+μ₁u₂[k]u₁[k−m]
W₂^{k+1}[m]=W₂^{k}[m]+μ₂u₁[k]u₂[k−m]
m=0 . . . L

In the above algorithm, W1 is the adaptive filter coefficient for signal estimate, W2 is the adaptive filter coefficient for image estimate, μ1 is the LMS adjustment step size for W1, μ2 is the LMS adjustment step size for W2, u1 is the signal output, u2 is the image output, m is the mth tap of the adaptive filter 525 or 530, and L is a number of taps.

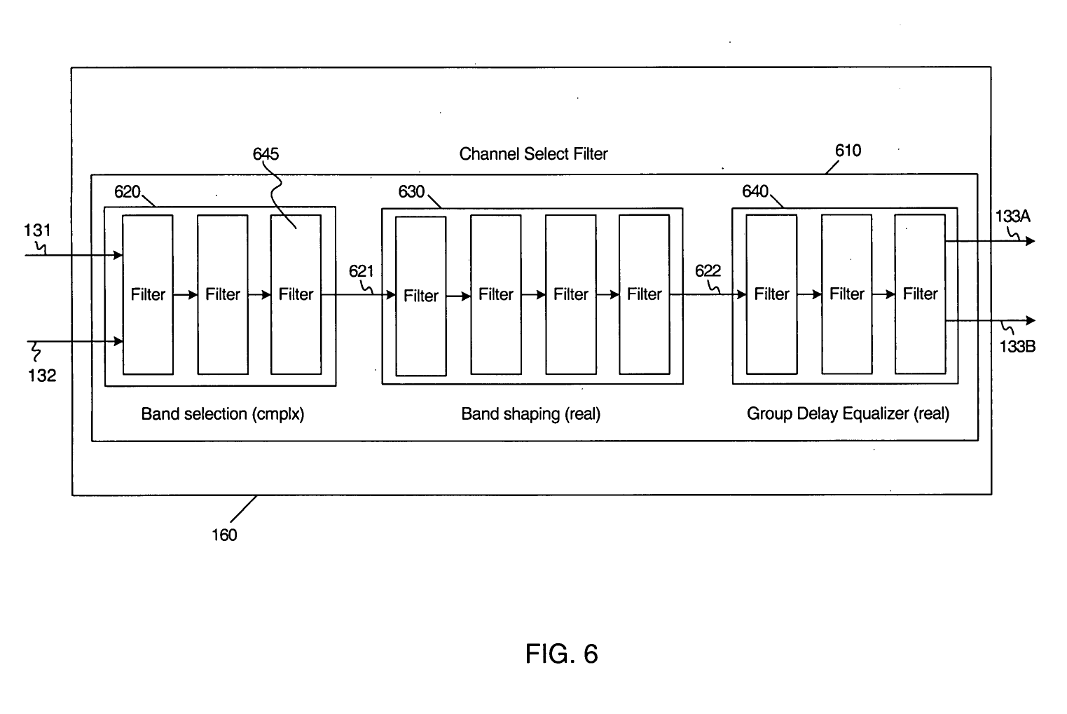

FIG. 6 illustrates a block diagram of the signal channel select filter 160, according to the preferred embodiment of the invention. As shown in the figure, the signal channel select filter 160 advantageously selects a desired signal from the received channels and rejects other, or undesired, channels. As illustrated in FIG. 6, the signal channel select filter 160 comprises a band selection module 620, a band shaping module 630, and a group delay equalizer 640. The band selection module 620 receives the signal 1131 and the signal Q 132 (i.e., collectively referred to as the enhanced image rejection signal) from the complex LMS image rejection module 155, and selects a band from the enhanced image rejection signal using one or more filters 645. The band selection module 620 preferably comprises three filters 645. The band selection module 620 outputs a signal 621 comprising the selected band to the band shaping module 630.

The band shaping module 630 receives the selected band from the band selection module 620. The band shaping module 630 shapes the spectrum of the selected band, which is advantageous in order to prepare the selected band for demodulation. The band shaping module 630 shapes the signal 621 from the selected band into a Vestigial Side Band (VSB) modulated signal 622, which, in general, is similar to a non-perfect Single Side Band (SSB) signal. The spectrum of the VSB signal 622 is not symmetrical with respect to the selected band's carrier frequency. The spectrum of one side of the carrier frequency is almost cut off and remains a “vestigial part”; therefore, the bandwidth of the spectrum is about one half of a normal spectrum. The band shaping module 630 comprises one or more filters 645 to perform band shaping. The band shaping module 630 preferably comprises four filters 645. The band shaping module 630 outputs the shaped band to the group delay equalizer 640.

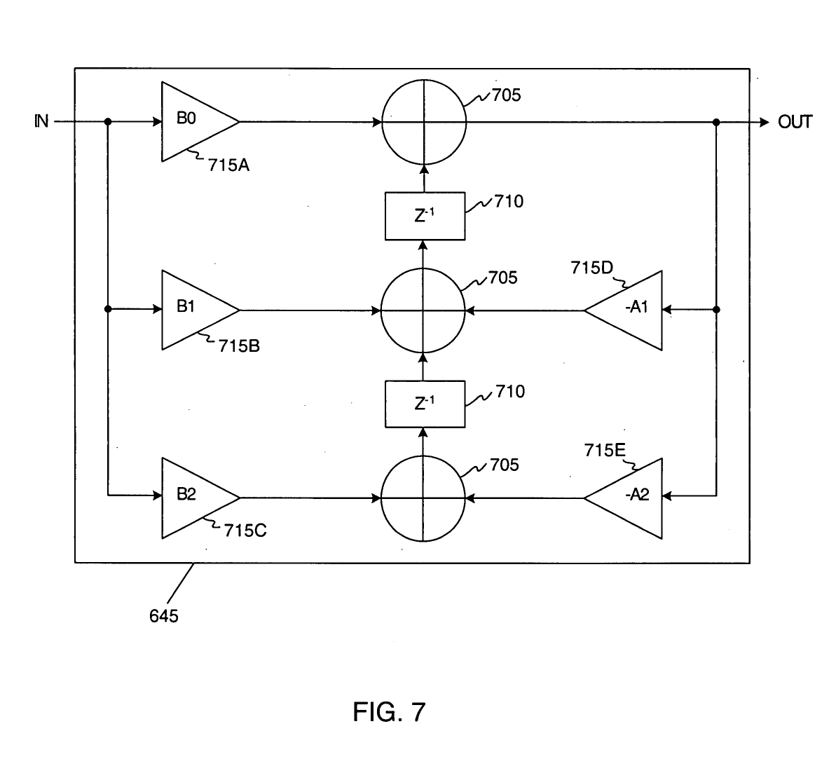

The group delay equalizer 640 receives the shaped VSB signal 622 and equalizes a group delay using one or more filters 645. In one embodiment, the group delay equalizer 640 comprises three filters 645. The group delay equalizer 640 outputs equalized signals 133A and 133B. Accordingly, as illustrated, the signal channel select filter 160 receives signals 131 and 132, selects a band from the signals 131 and 132, shapes the spectrum of the band (i.e., shapes a signal of the selected band), equalizes the group delay of the signal, and outputs the equalized signals 133A and 133B. In the preferred embodiment, the filter 645 is a second-order biquadratic filter utilizing a Direct Form II transposed IIR (Infinite Impedance Impulse Response), as described further below in conjunction with FIG. 7.

FIG. 7 illustrates a circuit diagram of an exemplary conventional second-order biquadratic filter 645, according to the preferred embodiment of the invention. The second-order biquadratic filter 645, incorporated herein by reference to Alan V. Openheim and Ronald W. Schafer, Digital Signal Processing, Prentice Hall, Eagle-Wood, 1974, comprises a plurality of summers 705, delay modules 710, and amplifiers 715 for signal scaling. The second-order biquadratic filter 645 operates according to the following formula:

$$H ( z ) = \frac{B0 + B1 \cdot {z}^{- 1} + B2 \cdot {z}^{- 2}}{1 + A1 \cdot {z}^{- 1} + A2 \cdot {z}^{- 2}}$$

In the above formula, B0, B1, and B2 are feed-forward filter coefficients, A1 and A2 are feedback filter coefficients, and z-n is a delay element of order n.

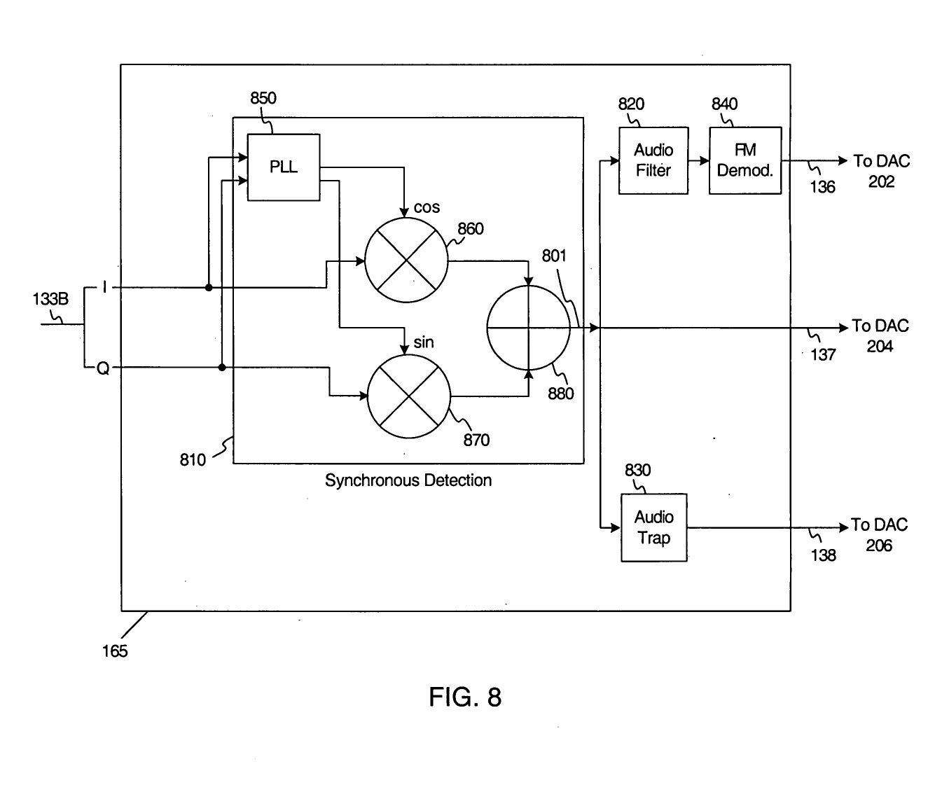

FIG. 8 illustrates an exemplary circuit diagram of the demodulator 165 shown in FIG. 2B, according to a preferred embodiment of the invention. As illustrated, the demodulator 165 comprises a synchronous detection module 810, an audio filter 820, an audio trap 830, and an FM demodulator 840. As illustrated, the demodulator 165 receives the signal 133B (comprised of an in-phase I signal and a quadrature Q signal), and processes the signal 133B to generate three digital output signals: a digital mono audio signal 136, a digital composite second intermediate frequency (SIF) audio signal 137, and a digital composite video baseband signal 138.

FIG. 8 also illustrates the synchronous detection module 810. The synchronous detection module 810 comprises a conventional phase-lock loop (PLL) 850, a cosine mixer 860, a sine mixer 870, and a mixer adder 880. The PLL 850 receives the signal 133B comprised of equalized I and Q signals from the signal channel select filter 160 and outputs a first signal to the cosine mixer 860 and a second signal to the sine mixer 870. The objective of the PLL 850 is to recover a frequency and a phase of a video carrier for synchronous demodulation of a video signal. The cosine mixer 860 receives and mixes the first signal from the PLL 850 with the I signal from the signal channel select filter 160, and the cosine mixer 860 outputs a first resulting signal to the mixer adder 880. The sine mixer 870 receives and mixes the second signal from the PLL 850 with the Q signal from the signal channel select filter 160, and the sine mixer 870 outputs a second resulting signal to the mixer adder 880. The mixer adder 880 receives and mixes the first resulting signal from the cosine mixer 860 and the second resulting signal from the sine mixer 870 to generate an output signal 801.

The output signal 801 from the mixer adder 880 is converted to an audio signal by passing the output signal 801 through the audio filter 820 and the FM demodulator 840, as illustrated in FIG. 8. In addition, the output signal 801 from the mixer adder 880 is transmitted as a composite SIF audio signal. Furthermore, the output signal 801 from the mixer adder 880 is converted to a composite video baseband signal by passing the output signal 801 through the audio trap 830, as illustrated in FIG. 8. Accordingly, in the embodiment described above, the demodulator 165 converts the received signal 133B comprised of I and Q component signals into the digital mono audio signal 136, the digital composite SIF audio signal 137, and the digital compositive video baseband signal 138. Referring back to FIG. 2B, the DACs 202, 204, and 206 receive the digital mono audio signal 136, the digital composite SIF audio signal 137, and the digital compositive video baseband signal 138, and convert the signals to an analog mono audio signal 139, an analog composite SIF audio signal 141, and an analog compositive video baseband signal 142, respectively.

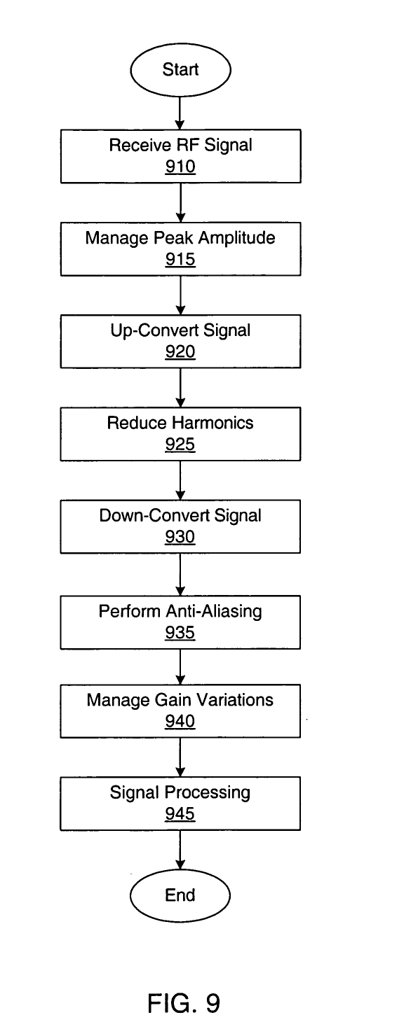

FIG. 9 illustrates a process flow diagram for tuning a radio frequency signal, according to an embodiment of the invention. At Step 910, the tuner 100 receives a radio frequency signal. The tuner 100 is described above and in reference to FIGS. 1A-2A and FIGS. 2A-2B. At Step 915, the tuner 100 sets a peak amplitude of the radio frequency signal. At Step 920, the tuner 100 up-converts the signal to a first intermediate frequency signal by increasing the frequency of the radio frequency signal. At Step 925, the tuner 100 reduces the harmonics of the first intermediate frequency signal. At Step 930, the tuner 100 down-converts the first intermediate frequency signal to a complex intermediate frequency signal with in-phase and quadrature-phase components. At Step 935, the tuner 100 performs anti-aliasing on the complex intermediate frequency signal. At Step 940, the tuner 100 manages gain variations of the complex intermediate frequency signal. At Step 945, the tuner 100 performs signal processing on the complex intermediate frequency signal. After Step 945, the tuner outputs the signal.

The invention has been described above with reference to exemplary embodiments. It will be apparent to those skilled in the art that various modifications may be made and other embodiments can be used without departing from the broader scope of the invention. Therefore, variations upon the specific embodiments are intended to be covered by the invention.

1. A tuner integrated on a computer chip for tuning a radio frequency signal, comprising:
an analog RF section configured to process the radio frequency signal to generate a complex intermediate frequency digital signal;
an image rejection module configured to perform image rejection on the complex intermediate frequency digital signal to generate an enhanced image rejection signal;
a signal channel select filter configured to perform digital on-chip filtering on the enhanced image rejection signal to generate a filtered signal; and
a demodulator configured to demodulate the filtered signal to generate digital output signals.

2. The tuner of claim 1, wherein the analog RF section further comprises:
an amplifier, configured to maintain a constant peak amplitude of the radio frequency signal;
a synthesizer, configured to generate a first synthesized signal and a second synthesized signal;
an up-conversion module, configured to receive the radio frequency signal from the amplifier and the first synthesized signal from the synthesizer to increase a frequency of the radio frequency signal received from the amplifier, resulting in an intermediate frequency signal;
a tuning amplifier, configured to reduce harmonics of the intermediate frequency signal;
a down-conversion module configured to receive the intermediate frequency signal from the tuning amplifier and the second synthesized signal from the synthesizer to decrease the frequency of the intermediate frequency signal, resulting in a complex intermediate frequency signal;
a filter/gain control module, configured to perform anti-aliasing on the complex intermediate frequency signal and manage gain variations of the complex intermediate frequency signal; and
an analog-to-digital converter module configured to convert the complex intermediate frequency signal to the complex intermediate frequency digital signal.

3. The tuner of claim 1, wherein the complex intermediate frequency digital signal comprises a signal band and an image band, the image rejection module further comprising:
an image rejection engine configured to apply an algorithm to estimate a signal correlation between the signal band and the image band.

4. The tuner of claim 3, wherein the algorithm comprises an adaptive complex least mean square algorithm.

5. The tuner of claim 3, wherein the image rejection module further comprises:
a first adaptive filter, the first adaptive filter comprising a first adaptive filter coefficient, configured to filter the image band according to the first adaptive filter coefficient, whereby the image rejection module adjusts the first adaptive filter coefficient, applies the first adaptive filter to the image band to estimate an image leakage, and subtracts the image leakage from the signal band, thereby reducing the image leakage in the signal band.

6. The tuner of claim 3 wherein the image rejection module further comprises:
a second adaptive filter, the second adaptive filter comprising a second adaptive filter coefficient, configured to filter the signal band according to the second adaptive filter coefficient, whereby the image rejection module adjusts the second adaptive filter coefficient, applies the second adaptive filter to the signal band to estimate a signal leakage, and subtracts the signal leakage from the image band, thereby reducing the signal leakage in the image band.

7. The tuner of claim 1, wherein the tuner is substantially monolithic.

8. The tuner of claim 1, wherein the signal channel select filter comprises at least one biquadratic filter for selecting a signal band from the enhanced image rejection signal.

9. The tuner of claim 8, wherein the signal channel select filter comprises the at least one biquadratic filter for shaping a spectrum of the selected signal band to generate a shaped band.

10. The tuner of claim 9, wherein the signal channel select filter comprises the at least one biquadratic filter for equalizing a group delay of the shaped band.

11. The tuner of claim 1, wherein the demodulator processes the filtered signal to generate a digital mono audio signal.

12. The tuner of claim 1, wherein the demodulator processes the filtered signal to generate a digital composite second intermediate frequency audio signal.

13. The tuner of claim 1, wherein the demodulator processes the filtered signal to generate a digital composite video baseband signal.

14. The tuner of claim 1, further comprising at least one digital-to-analog converter for converting the digital output signals to analog output signals.

15. The tuner of claim 1, further comprising a comparator module to digitally control the analog RF section, the comparator module configured to compare the filtered signal and a threshold signal to generate control signals, the control signals applied to the analog RF section.

16. A tuner integrated on a computer chip to perform image rejection on a complex intermediate frequency digital signal, the complex intermediate frequency digital signal comprising a signal band and an image band, the tuner comprising:
an image rejection module, configured to apply an algorithm to estimate a signal correlation between the signal band and the image band.

17. The tuner of claim 16, wherein the image rejection module further comprises:
an adaptive filter, the adaptive filter comprising adaptive filter coefficients, configured to filter the image band according to the adaptive filter coefficients.

18. The tuner of claim 17, wherein the image rejection module adjusts the adaptive filter coefficients, applies the adaptive filter to the image band to estimate an image leakage, and subtracts the image leakage from the signal band, thereby reducing the image leakage in the signal band.

19. A method for tuning a radio frequency signal, comprising:
processing the radio frequency signal to generate a complex intermediate frequency digital signal;
performing image rejection on the complex intermediate frequency digital signal to generate an enhanced image rejection signal;
performing digital on-chip filtering on the enhanced image rejection signal to generate a filtered signal; and
demodulating the filtered signal to generate digital output signals.

20. The method of claim 19, wherein performing image rejection comprises applying an adaptive complex least mean square algorithm to the complex intermediate frequency digital signal.

21. The method of claim 19, wherein performing digital on-chip filtering comprises selecting a signal band from the enhanced image rejection signal.

22. The method of claim 21, wherein performing digital on-chip filtering comprises shaping a spectrum of the selected signal band to generate a shaped band.

23. The method of claim 22, wherein performing digital on-chip filtering comprises equalizing a group delay of the shaped band.

24. The method of claim 19, wherein demodulating the filtered signal comprises generating a digital mono audio signal.

25. The method of claim 19, wherein demodulating the filtered signal comprises generating a digital composite second intermediate frequency audio signal.

26. The method of claim 19, wherein demodulating the filtered signal comprises generating a digital composite video baseband signal.

27. The method of claim 19, further comprising comparing the filtered signal and a threshold signal to generate control signals for digitally controlling amplification of the complex intermediate frequency digital signal.

28. A method of performing on-chip image rejection on a complex intermediate frequency digital signal, wherein the complex intermediate frequency digital signal comprises a signal band and an image band, comprising the steps of:
applying an algorithm to estimate a signal correlation between the signal band and the image band; and
adjusting adaptive filter coefficients of an adaptive filter according to the estimated signal correlation.

29. The method of claim 28, further comprising the step of:
applying the adaptive filter to the image band to estimate an image leakage.

30. The method of claim 29, further comprising the step of:
subtracting the image leakage from the signal band, thereby reducing the image leakage in the signal band.

31. The method of claim 28, further comprising the step of:
applying the adaptive filter to the signal band to estimate a signal leakage.

32. The method of claim 31, further comprising the step of:
subtracting the signal leakage from the image band, thereby reducing the signal leakage in the image band.

33. The method of claim 28, wherein the algorithm comprises an adaptive complex least mean square algorithm.

34. A tuner integrated on a computer chip for tuning a radio frequency signal, comprising:
means for processing the radio frequency signal to generate a complex intermediate frequency digital signal, the complex intermediate frequency digital signal comprising a signal band and an image band;
means for performing image rejection on the complex intermediate frequency digital signal to generate an enhanced image rejection signal;
means for performing digital on-chip filtering on the enhanced image rejection signal to generate a filtered signal; and
means for demodulating the filtered signal to generate digital output signals.

35. The tuner of claim 34, wherein the means for performing image rejection comprises applying an algorithm to estimate a signal correlation between the signal band and the image band.

36. The tuner of claim 35, further comprising:
means for providing adaptive filtering based upon the estimated signal correlation, thereby reducing an image leakage in the signal band.

37. The tuner of claim 35, further comprising:
means for providing adaptive filtering based upon the estimated signal correlation, thereby reducing a signal leakage in the image band.
